(19) United States
(12) Patent Application Publication
(10) Pub. No.: US 2010/0329897 A1
(43) Pub. Date: Dec. 30, 2010

(54) METHOD FOR PROCESSING THE VALVE PLATE OF A RECIPROCATING COMPRESSOR TO PREVENT THE SUCTION VALVES AND/OR THE DISCHARGE VALVE OF THE COMPRESSOR FROM STICKING ON THE VALVE PLATE AT THE PORTIONS ABUTTING THE VALVE PLATE, AND RECIPROCATING COMPRESSOR

(75) Inventor: Junya Satou, Gunma (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: SANDEN CORPORATION, Isesaki-shi, Gunma (JP)

(21) Appl. No.: 12/918,057

(22) PCT Filed: Feb. 4, 2009
(86) PCT No.: PCT/JP2009/051901

§ 371 Date: Aug. 17, 2010

(30) Foreign Application Priority Data
Feb. 17, 2008 (JP) 2008-035400 2008

(51) Int. Cl. F04B 27/08; F04B 39/10; B23P 15/00

(52) U.S. Cl. 417/269; 29/888.02

(57) ABSTRACT

[Object of the Invention] An object of the present invention is to provide a method for processing the valve plate of a reciprocating compressor to prevent the suction valves and/or the discharge valves of the compressor from sticking on the valve plate at the portions abutting the valve plate, the productivity thereof being higher than that of the conventional method.

[Disclosure of the Invention] A method for processing the valve plate 8 of a reciprocating compressor 1 to prevent the suction valves 10a and/or the discharge valves 10b from sticking on the valve plate 8 at the portions abutting the valve plate 8 comprises the steps of rotating the valve plate 8, moving a cutting tool or a grinding tool in the radial direction and in the longitudinal direction of the central axis of the rotation of the valve plate 8, and forming an annular mound including the suction holes 8a, or an annular mound including the discharge holes 8b, or an annular mound including the suction holes 8a and an annular mound including the discharge holes 8b.

Method for processing the valve plate of a reciprocating compressor to prevent the suction valves and/or the discharge valves of the compressor from sticking on the valve plate at the portions abutting the valve plate, and reciprocating compressor

### TECHNICAL FIELD

The present invention relates to a method for processing the valve plate of a reciprocating compressor to prevent the suction valves and/or the discharge valves of the compressor from sticking on the valve plate at the portions abutting the valve plate, and a reciprocating compressor.

### BACKGROUND ART

Patent Document No. 1 teaches a method for processing the valve plate of a reciprocating compressor to prevent the suction valves and/or the discharge valves of the compressor from sticking on the valve plate at the portions abutting the valve plate, wherein the compressor comprises a plurality of cylinder bores, a plurality of pistons fitted in the plurality of cylinder bores to be capable of reciprocal movement, a valve plate provided with a plurality of suction holes communicating with the cylinder bores and a plurality of discharge holes communicating with the cylinder bores, a plurality of strap-shaped suction valves for opening and closing the suction holes, a plurality of strap-shaped discharge valves for opening and closing the discharge holes, a suction chamber communicating with the cylinder bores through the suction holes and the suction valves, and a discharge chamber communicating with the cylinder bores through the discharge valves and the discharge holes, and wherein the method comprises the steps of melting and sputtering the portions of the end face of the valve plate abutting the suction valves around the suction holes by laser beam machining and/or the portions of the end face of the valve plate abutting the discharge valves around the discharge holes by laser beam machining, and making the non-laser-beam-machined-portions protrude from the laser-beam-machined-portions.

The method of the Patent Document No. 1 has various advantages over the conventional processing method wherein protrusions are made by shot blasting, including, for example, that the processing media do not remain, the protrusions are formed precisely, etc.

Patent Document No. 1: Japanese Patent Laid-Open Publication No. 2007-064196

### DISCLOSURE OF INVENTION

### Problem to be Solved

The method of the Patent Document No. 1 has a disadvantage in that the productivity is low because precise processing is required to melt and sputter a part of the valve plate, and thereby form the protrusions.

The present invention is directed to solving the aforementioned problem. An object of the present invention is to provide a method for processing the valve plate of a reciprocating compressor to prevent the suction valves and/or the discharge valves of the compressor from sticking on the valve plate at the portions abutting the valve plate, wherein the compressor comprises a plurality of cylinder bores, a plurality of pistons fitted in the plurality of cylinder bores to be capable of reciprocal movement, a valve plate provided with a plurality of suction holes communicating with the cylinder bores and a plurality of discharge holes communicating with the cylinder bores, a plurality of strap-shaped suction valves for opening and closing the suction holes, a plurality of strap-shaped discharge valves for opening and closing the discharge holes, a suction chamber communicating with the cylinder bores through the suction holes and the suction valves, and a discharge chamber communicating with the cylinder bores through the discharge valves and the discharge holes, and wherein the productivity is higher than that in the method of the Patent Document No. 1.

### Means for Achieving the Object

In accordance with the present invention, there is provided a method for processing the valve plate of a reciprocating compressor to prevent the suction valves from sticking on the valve plate at the portions abutting the valve plate, wherein the compressor comprises a plurality of cylinder bores disposed distanced from each other on the circumference of a first circle, a plurality of pistons fitted in the plurality of cylinder bores to be capable of reciprocal movement, a valve plate provided with a plurality of suction holes disposed distanced from each other on the circumference of a second circle coaxial with the first circle to communicate with the cylinder bores and a plurality of discharge holes disposed distanced from each other on the circumference of a third circle coaxial with the second circle to communicate with the cylinder bores, a plurality of strap-shaped suction valves for opening and closing the suction holes, a plurality of strap-shaped discharge valves for opening and closing the discharge holes, a suction chamber communicating with the cylinder bores through the suction holes and the suction valves, and a discharge chamber communicating with the cylinder bores through the discharge valves and the discharge holes, and wherein the method comprises the steps of rotating the valve plate around the central axis of the second circle, moving a cutting tool or a grinding tool in the radial direction and in the longitudinal direction of the central axis of the second circle to cut or grind the end face of the valve plate opposing the suction valves, and forming an annular mound including the suction holes on the end face of the valve plate.

In another aspect of the present invention, there is provided a method for processing the valve plate of a reciprocating compressor to prevent the discharge valves from sticking on the valve plate at the portions abutting the valve plate, wherein the compressor comprises a plurality of cylinder bores disposed distanced from each other on the circumference of a first circle, a plurality of pistons fitted in the plurality of cylinder bores to be capable of reciprocal movement, a valve plate provided with a plurality of suction holes disposed distanced from each other on the circumference of a second circle coaxial with the first circle to communicate with the cylinder bores and a plurality of discharge holes disposed distanced from each other on the circumference of a third circle coaxial with the second circle to communicate with the cylinder bores, a plurality of strap-shaped suction valves for opening and closing the suction holes, a plurality of strap-shaped discharge valves for opening and closing the discharge holes, a suction chamber communicating with the cylinder bores through the suction holes and the suction valves, and a discharge chamber communicating with the cylinder bores through the discharge valves and the discharge holes, and wherein the method comprises the steps of rotating the valve plate around the central axis of the second circle, moving a cutting tool or a grinding tool in the radial direction and in the longitudinal direction of the central axis of the second circle to cut or grind the end face of the valve plate opposing the discharge valves, and forming an annular mound including the discharge holes on the end face of the valve plate.

In another aspect of the present invention there is provide a method for processing the valve plate of a reciprocating compressor to prevent the suction valves from sticking on the valve plate at the portions abutting the valve plate and the discharge valves from sticking on the valve plate at the portions abutting the valve plate, wherein the compressor comprises a plurality of cylinder bores disposed distanced from each other on the circumference of a first circle, a plurality of pistons fitted in the plurality of cylinder bores to be capable of reciprocal movement, a valve plate provided with a plurality of suction holes disposed distanced from each other on the circumference of a second circle coaxial with the first circle to communicate with the cylinder bores and a plurality of discharge holes disposed distanced from each other on the circumference of a third circle coaxial with the second circle to communicate with the cylinder bores, a plurality of strap-shaped suction valves for opening and closing the suction holes, a plurality of strap-shaped discharge valves for opening and closing the discharge holes, a suction chamber communicating with the cylinder bores through the suction holes and the suction valves, and a discharge chamber communicating with the cylinder bores through the discharge valves and the discharge holes, and wherein the method comprises the steps of rotating the valve plate around the central axis of the second circle, moving a cutting tool or a grinding tool in the radial direction and in the longitudinal direction of the central axis of the second circle to cut or grind the end face of the valve plate opposing the suction valves and the end face of the valve plate opposing the discharge valves, thereby forming an annular mound including the suction holes on the end face of the valve plate opposing the suction valves and an annular mound including the discharge holes on the end face of the valve plate opposing the discharge valves.

In the present invention, an annular mound including suction holes is formed on one of the end faces of the valve plate and/or an annular mound including discharge holes is formed on the other of the end faces of the valve plate. Therefore, the tip portions of the suction valves and/or the discharge valves are lifted up by the mounds or the mound to separate from the portions of the end faces other than the mounds or the portion of one or the other of the end faces other than the mounds. Thus, the strength of the oil films residing between the suction valves and/or the discharge valves and the valve plate decreases to prevent the suction valves and/or the discharge valves from sticking on the valve plate at the portions abutting the valve plate.

In the present invention, the valve plate is rotated, a cutting tool or a grinding tool is moved in the radial direction and in the longitudinal direction of the central axis of the rotation of the valve plate to cut or grind the end face of the valve plate, and an annular mound including the suction holes is formed on one of the end faces of the valve plate, or an annular mound including the discharge holes is formed on the other of the end faces of the valve plate, or an annular mound including the suction holes is formed on one of the end faces of the valve plate and an annular mound including the discharge holes is formed on the other of the end faces of the valve plate. Therefore, the productivity is high.

When the mound is too low, the mound wears easily. When the mound is too high, the valves become hard to close. Therefore, the height of the mound is desirably 10 to 300 μm.

In accordance with the present invention, there is provided a reciprocating compressor, wherein the valve plate is processed by one of the aforementioned methods.

The reciprocating compressor in accordance with the present invention does not suffer from sticking of the valves on the valve plate. The productivity of the reciprocating compressor in accordance with the present invention is high.

### EFFECT OF THE INVENTION

In accordance with the present invention, there is provided a method for processing, with high productivity, the valve plate of a reciprocating compressor to prevent the suction valves and/or the discharge valves of the compressor from sticking on the valve plate at the portions abutting the valve plate.

### BEST MODE FOR CARRYING OUT THE INVENTION

A method for processing the valve plate of a reciprocating compressor in accordance with a preferred embodiment of the present invention will be described.

### Preferred Embodiment No. 1

As shown in FIG. 1, a variable displacement swash plate compressor 1 comprises a cylinder block 2 provided with a plurality of cylinder bores 2a of circular cross section, a front head 4 cooperating with the cylinder block 2 to form a crank chamber 3, a rotation shaft 5 disposed in the crank chamber 3, rotatably supported by the cylinder block 2 and the front head 4, and extending out of the compressor through the front head 4 at one end, a swash plate 6 engaging the rotation shaft 5 at a variable inclination and rotated by the rotation shaft 5, a plurality of pistons 7 fitted in the cylinder bores 2a, engaging the swash plate 6, and reciprocally moving synchronously with the rotation of the swash plate 6, a cylinder head 9 accommodating an annular-hollow-shaped suction chamber 9a and a disk-hollow-shaped discharge chamber 9b and cooperating with the cylinder block 2 to clamp a valve plate 8 provided with a plurality of suction holes 8a and discharge holes 8b, a plurality of strap-shaped suction valves 10a clamped by the cylinder block 2 and the valve plate 8 to be fixed at one ends and opening and closing the suction holes 8a at the other ends, and a plurality of strap-shaped discharge valves 10b clamped by valve retainers 11 and the valve plate 8 to be fixed at one ends and opening and closing the discharge holes 8b at the other ends.

The plurality of cylinder bores 2a are disposed circumferentially distanced from each other on the circumference of a first circle with the central axis thereof coinciding with the central axis X of the rotation shaft 5. The plurality of suction holes 8a are disposed circumferentially distanced from each other on the circumference of a second circle with the central axis thereof coinciding with the central axis X of the rotation shaft 5. The plurality of discharge holes 8b are disposed circumferentially distanced from each other on the circumference of a third circle with the central axis thereof coinciding with the central axis X of the rotation shaft 5. The suction chamber 9a communicates with an evaporator of a car air conditioner not shown in FIG. 1 through a suction port 9a′ and with the cylinder bores 2a through the suction holes 8a and the suction valves 10a.

The discharge chamber 9b communicates with a condenser of a car air conditioner not shown in FIG. 1 through a discharge port 9b′ and with the cylinder bores 2a through the discharge valves 10b and the discharge holes 8b.

A plurality of concaves 2b are formed on the end face of the cylinder block 2 opposing the valve plate 8 to restrict the lifts of the suction valves 10a.

As shown in FIGS. 2 and 3, an annular mound 8c including the discharge holes 8b is formed on the end face of the valve plate 8 opposing the discharge valves 10b. The width of the mound 8c is larger than the diameter of the discharge holes 8b. The height of the mound 8c is 10 to 300 μM. The top of the mound 8c is flat. The mound 8c is processed by a method comprising the steps of rotating the valve plate 8 around the central axis X, and moving a cutting tool or a grinding tool in the radial direction and in the longitudinal direction of the central axis X to cut or grind the end face of the valve plate 8.

In the variable displacement swash plate compressor 1, the rotation shaft 5 is rotated by a car engine not shown in Figures, the swash plate 6 rotates synchronously with the rotation of the rotation shaft 5, and the pistons 7 reciprocally move. Synchronously with the reciprocal movement of the pistons 7, coolant gas returns to the compressor from the evaporator of the car air conditioner, flows into the cylinder bores 2a through the suction port 9a′, the suction chamber 9a, the suction holes 8a and the suction valves 10a, becomes compressed in the cylinder bores 2a, and flows out of the compressor 1 to the condenser of the car air conditioner through the discharge holes 8b, the discharge valves 10b, the discharge chamber 9b and the discharge port 9b′.

In the variable displacement swash plate compressor 1, the annular mound 8c including discharge holes 8b is formed on the end face of the valve plate 8 opposing the discharge valves 10b. Therefore, as seen from FIG. 3, the tip portions of the discharge valves 10b are lifted up by the mound 8c to separate from the portion of the end face other than the mound 8c. Thus, the strength of the oil film residing between the discharge valves 10b and the valve plate 8 decreases, the discharge valves 10b are prevented from sticking on the valve plate 8 at the portions abutting the valve plate 8, delays in the opening actions of the discharge valves 10b are prevented, and damage of the discharge valves 10b and generation of noises caused by hard collisions between the discharge valves 10b and the valve retainers 11 due to delays in the opening actions of the discharge valves 10b are prevented.

In the variable displacement swash plate compressor 1, the valve plate 8 is rotated, a cutting tool or a grinding tool is moved in the radial direction and in the longitudinal direction of the central axis X to cut or grind the end face of the valve plate 8, and an annular mound 8c including the discharge holes 8b is formed on the end face of the valve plate 8. The productivity of the method for forming the mound 8c in accordance with the present preferred embodiment is higher than that of the method wherein a laser beam is applied to a part of the valve plate 8 to melt and sputter it, thereby forming the mound 8c.

When the mound is too low, the mound wears easily. When the mound is too high, the valve becomes hard to close. Therefore, the height of the mound is desirably 10 to 300 μm.

In the aforementioned preferred embodiment, the mound 8c is formed on the end face of the valve plate 8 opposing the discharge valves 10b to prevent the discharge valves 10b from sticking on the valve plate 8. Instead of the mound 8c or in addition to the mound 8c, it is possible to form an annular mound including the suction holes 8a on the end face of the valve plate 8 opposing the suction valves 10a, the width thereof being larger than the diameter of the suction holes 8a, and the height thereof being 10 to 300 μm, in the same way as the mound 8c. Thus, the suction valves 10a are prevented from sticking on the valve plate 8 at the portions abutting the valve plate 8, delays in the opening actions of the suction valves 10a are prevented, and damage of the suction valves 10a and generation of noises caused by hard collisions between the tips of the suction valves 10a and the restricting surfaces of the concaves 2b for restricting the lift of the suction valves 10a due to delays in the opening actions of the suction valves 10a are prevented.

### INDUSTRIAL APPLICABILITY

The present invention can be widely used in various kinds of reciprocating compressors including swash plate compressors, wobble plate compressors, etc.

### BRIEF DESCRIPTION OF THE DRAWINGS

FIG. 1 is a sectional view of a variable displacement swash plate compressor to which the method for processing the valve plate in accordance with a preferred embodiment of the present invention is used.

FIG. 2 is a view in the direction of arrows II-II in FIG. 1.

FIG. 3 is a view in the direction of arrows in FIG. 2.

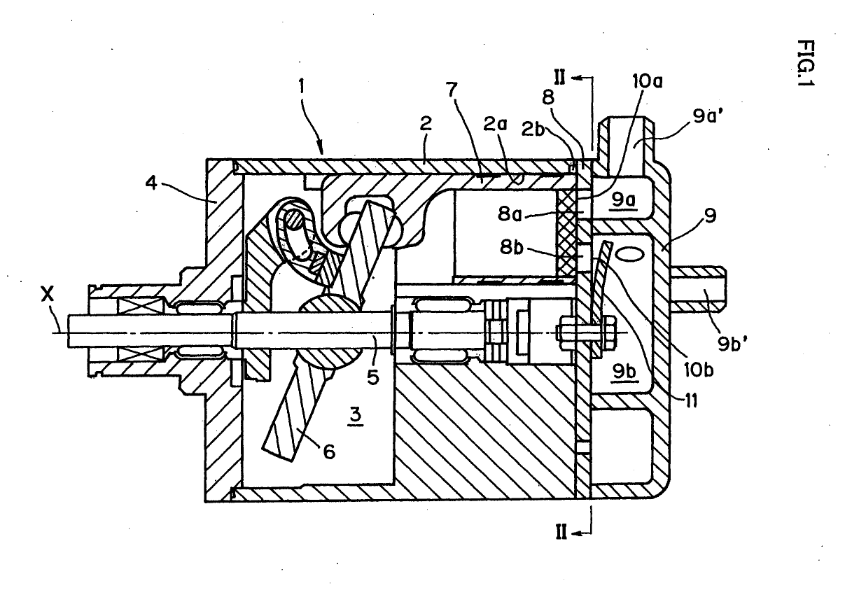

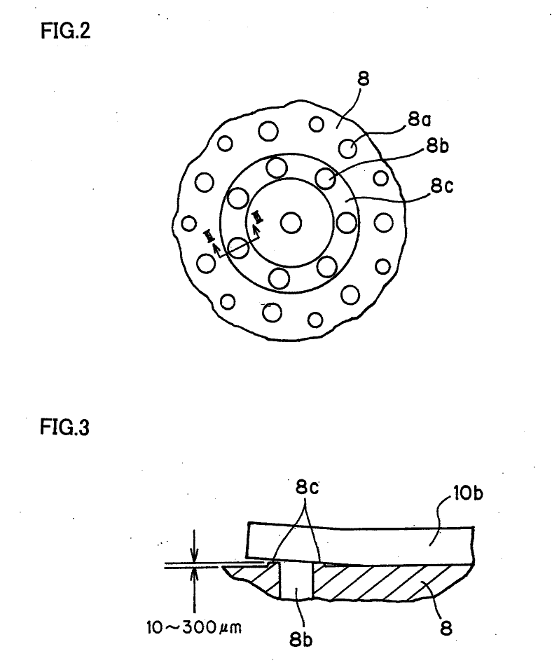

### BRIEF DESCRIPTION OF THE REFERENCE NUMERALS

1 Variable displacement swash plate compressor
2 Cylinder block
2a Cylinder bore
2b Concave for restricting the lift
3 Crank chamber
4 Front head
5 Rotation shaft
6 Swash plate
7 Piston
8 Valve plate
8a Suction hole
8b Discharge hole
8c Mound
9 Cylinder head
9a Suction chamber
9b Discharge chamber
10a Suction valve
10b Discharge valve
11 Valve retainer

1. A method for processing the valve plate of a reciprocating compressor to prevent the suction valves from sticking on the valve plate at the portions abutting the valve plate, wherein the compressor comprises a plurality of cylinder bores disposed distanced from each other on the circumference of a first circle, a plurality of pistons fitted in the plurality of cylinder bores to be capable of reciprocal movement, a valve plate provided with a plurality of suction holes disposed distanced from each other on the circumference of a second circle coaxial with the first circle to communicate with the cylinder bores and a plurality of discharge holes disposed distanced from each other on the circumference of a third circle coaxial with the second circle to communicate with the cylinder bores, a plurality of strap-shaped suction valves for opening and closing the suction holes, a plurality of strap-shaped discharge valves for opening and closing the discharge holes, a suction chamber communicating with the cylinder bores through the suction holes and the suction valves, and a discharge chamber communicating with the cylinder bores through the discharge valves and the discharge holes, and wherein the method comprises the steps of rotating the valve plate around the central axis of the second circle, moving a cutting tool or a grinding tool in the radial direction and in the longitudinal direction of the central axis of the second circle to cut or grind the end face of the valve plate opposing the suction valves, and forming an annular mound including the suction holes on the end face of the valve plate.

2. A method for processing the valve plate of a reciprocating compressor to prevent the discharge valves from sticking on the valve plate at the portions abutting the valve plate, wherein the compressor comprises a plurality of cylinder bores disposed distanced from each other on the circumference of a first circle, a plurality of pistons fitted in the plurality of cylinder bores to be capable of reciprocal movement, a valve plate provided with a plurality of suction holes disposed distanced from each other on the circumference of a second circle coaxial with the first circle to communicate with the cylinder bores and a plurality of discharge holes disposed distanced from each other on the circumference of a third circle coaxial with the second circle to communicate with the cylinder bores, a plurality of strap-shaped suction valves for opening and closing the suction holes, a plurality of strap-shaped discharge valves for opening and closing the discharge holes, a suction chamber communicating with the cylinder bores through the suction holes and the suction valves, and a discharge chamber communicating with the cylinder bores through the discharge valves and the discharge holes, and wherein the method comprises the steps of rotating the valve plate around the central axis of the second circle, moving a cutting tool or a grinding tool in the radial direction and in the longitudinal direction of the central axis of the second circle to cut or grind the end face of the valve plate opposing the discharge valves, and forming an annular mound including the discharge holes on the end face of the valve plate.

3. A method for processing the valve plate of a reciprocating compressor to prevent the suction valves from sticking on the valve plate at the portions abutting the valve plate and the discharge valves from sticking on the valve plate at the portions abutting the valve plate, wherein the compressor comprises a plurality of cylinder bores disposed distanced from each other on the circumference of a first circle, a plurality of pistons fitted in the plurality of cylinder bores to be capable of reciprocal movement, a valve plate provided with a plurality of suction holes disposed distanced from each other on the circumference of a second circle coaxial with the first circle to communicate with the cylinder bores and a plurality of discharge holes disposed distanced from each other on the circumference of a third circle coaxial with the second circle to communicate with the cylinder bores, a plurality of strap-shaped suction valves for opening and closing the suction holes, a plurality of strap-shaped discharge valves for opening and closing the discharge holes, a suction chamber communicating with the cylinder bores through the suction holes and the suction valves, and a discharge chamber communicating with the cylinder bores through the discharge valves and the discharge holes, and wherein the method comprises the steps of rotating the valve plate around the central axis of the second circle, moving a cutting tool or a grinding tool in the radial direction and in the longitudinal direction of the central axis of the second circle to cut or grind the end face of the valve plate opposing the suction valves and the end face of the valve plate opposing the discharge valves, thereby forming an annular mound including the suction holes on the end face of the valve plate opposing the suction valves and an annular mound including the discharge holes on the end face of the valve plate opposing the discharge valves.

4. A method for processing the valve plate of claim 1, wherein the height of the mound is 10 to 300 μm.

5. A reciprocating compressor, wherein the valve plate is processed by the method of claim 1.

6. A method for processing the valve plate of claim 2, wherein the height of the mound is 10 to 300 μm.

7. A method for processing the valve plate of claim 3, wherein the height of the mound is 10 to 300 μm.

8. A reciprocating compressor, wherein the valve plate is processed by the method of claim 2.

9. A reciprocating compressor, wherein the valve plate is processed by the method of claim 3.

10. A reciprocating compressor, wherein the valve plate is processed by the method of claim 4.

11. A reciprocating compressor, wherein the valve plate is processed by the method of claim 6.

12. A reciprocating compressor, wherein the valve plate is processed by the method of claim 7.
